(19) United States
(12) Patent Application Publication
(10) Pub. No.: US 2014/0207390 A1
(43) Pub. Date: Jul. 24, 2014

(54) Coiled Tubing Useful Life Monitor And Technique

(71) Applicants: Shunfeng Zheng, Katy, TX (US); David P. Smith, Anchorage, AK (US)

(72) Inventors: Shunfeng Zheng, Katy, TX (US); David P. Smith, Anchorage, AK (US)

(73) Assignee: Schlumberger Technology Corporation, Sugar Land, TX (US)

(21) Appl. No.: 14/125,943

(22) PCT Filed: Jun. 13, 2012
(86) PCT No.: PCT/US12/42166

§ 371 Date: Feb. 12, 2014

Related U.S. Application Data
(60) Provisional application No. 61/496,399, filed on Jun. 13, 2011.

(51) Int. Cl. G01N 27/90

(52) U.S. Cl. CPC G01N 27/9073
USPC 702/34

(57) ABSTRACT

A system and technique for dynamically and historically evaluating useful life of coiled tubing. Methods are detailed wherein a monitor and system are equipped for enhanced evaluating of coiled tubing fatigue life based in part on the orientation of the coiled tubing during use. This may be obtained through the tracking of a seamweld of the coiled tubing. Additionally, reliability of the coiled tubing over various uses may be determined on an ongoing basis as a result of acoustically acquired data during operations. In either case, the monitor may be of a magnetic flux data detection variety.

### BACKGROUND

Exploring, drilling and completing hydrocarbon and other wells are generally complicated, time consuming and ultimately very expensive endeavors. As such, tremendous emphasis is often placed on well access in the hydrocarbon recovery industry. That is, access to a well at an oilfield for monitoring its condition and maintaining its proper health is of great importance. As described below, such access to the well is often provided by way of coiled tubing or slickline as well as other forms of well access lines.

Well access lines as noted may be configured to deliver interventional or monitoring tools downhole. In the case of coiled tubing and other tubular lines, fluid may also be accommodated through an interior thereof for a host of downhole applications. Coiled tubing is particularly well suited for being driven downhole, to depths of perhaps several thousand feet, by an injector at the surface of the oilfield. Thus, with these characteristics in mind, the coiled tubing will also generally be of sufficient strength and durability to withstand such applications. For example, the coiled tubing may be of alloy steel, stainless steel or other suitable metal based material.

In spite of being constructed of a relatively heavy metal based material, the coiled tubing is plastically deformed and wound about a drum to form a coiled tubing reel. Thus, the coiled tubing may be manageably delivered to the oilfield for use in a well thereat. More specifically, the tubing may be directed through the well by way of the noted injector equipment at the oilfield surface.

Unfortunately, due to the noted plastifying deformation which takes place during winding and unwinding of the above noted coiled tubing lines, the low cycle fatigue life of the coiled tubing is affected. That is, repeated cycling (e.g., winding and unwinding of the given line) will eventually cause the line to fail, losing its structural integrity in term of force bearing capacity, or pressure bearing capacity.

In order to ensure avoidance of coiled tubing fatigue failure during operations, the tubing is generally ‘retired’ once a predetermined fatigue life has been reached. So, for example, the coiled tubing reel may be equipped with a data storage system and processor. Thus, ongoing cycling or bending of the coiled tubing during an operation may be monitored and compared against a predetermined exemplary model of fatigue life. Indeed, a degree of accuracy may be provided whereby the bending of each segment of the coiled tubing, foot by foot, is tracked as it winds and unwinds from the reel and bends in one direction or another through the turns of the injector and advances into the well. As such, from one operation to the next, the actual degree of cycling for any given segment may be historically tracked. Therefore, retiring of the coiled tubing may ensue, once segments thereof begin to reach the limits established based on the predetermined model.

Unfortunately, the actual cycling that is undergone by the coiled tubing may fail to correlate to the predetermined model with an ideal degree of accuracy. More specifically, the predetermined model typically presumes a ‘worst case scenario’ of cycling for coiled tubing operations. The “worst case scenario” assumes that coiled tubing doesn't rotate during the operation, and each bend cycle always cause the maximum fatigue damage on the same location of the tubing segment, typically the outside diameter farthest from the neutral axis However, this may not actually be the case. That is, with reference to the radial center of the coiled tubing, it is generally the case that between the two such separate bending events, the coiled tubing has shifted rotational orientation relative its center to a degree. As such, the maximum fatigue damage caused by two separate bending cycles may not occur at the same physical location circumferentially for a given coiled tubing segment.

Ultimately the result of the accuracy limitations of the predetermined model is that it generally calls for premature retiring of coiled tubing. In a simplified example, consider a coiled tubing segment with a predetermined threshold of 1,000 cycles which is retired after a presumed 1,000 cycles. In fact, it may be the case that over the course of operational use, due to coiled tubing rotation, the most fatigue damage in the circumferential elements of the segment at issue has actually bent 750 cycles, with other circumferential elements experiencing a lower level of fatigue damage (e.g., 200 bend cycles, or 400 bend cycles). Nevertheless, utilizing the worst case scenario modeling, the coiled tubing may be retired prematurely with 25% of its fatigue life actually remaining in this particular example.

As a practical matter, this problem is often exacerbated by the perceived inaccuracy of the modeling. That is, operators often recognize that a presumed predetermined threshold of, for example, 1,000 cycles for a segment may actually correspond to much more than 1,000 bends of the segment. Thus, in an attempt to save time and costs, the operator may intentionally far exceed 1,000 bends for the segment. Unfortunately, this effort to avoid premature coiled tubing retirement is undertaken in a completely blind fashion. Thus, should there be a less than expected degree of tubing rotation between bends, the fatigue life model will end up actually being more accurate than expected. As such, any attempt to extend the use of the coiled tubing segment beyond the presumed ‘worst case scenario’ of 1,000 bends may result in catastrophic consequences. Such consequences may include failure of the coiled tubing during downhole operations requiring dramatic cost and time consuming remediation. As a result, operators are left with the undesirable conflict between engaging in such risky maneuvers or, more likely, prematurely retiring the coiled tubing.

### SUMMARY

A method is disclosed for monitoring fatigue life of coiled tubing. The method may include establishing a model of fatigue life for coiled tubing which addresses repeated bend cycles during operation. Thus, operations using the coiled tubing may be monitored and in a manner that includes tracking orientation of the coiled tubing during successive bend cycles. As such, current fatigue life of the coiled tubing may be determined, at least in part, with reference to the tracked orientation data in light of the model. Additionally, coiled tubing may be monitored for reliability over time with particular reliance on magnetic flux leakage (MFL) profile data. More specifically, an MFL profile may be established for coiled tubing such that when the coiled tubing is utilized in operations, changes to the profile may be tracked as a measure of coiled tubing reliability over time. Of course, this summary is provided to introduce a selection of concepts that are further described below and is not intended as an aid in limiting the scope of the claimed subject matter.

### BRIEF DESCRIPTION OF THE DRAWINGS

FIG. 1A is an overview of an oilfield accommodating a well whereat coiled tubing is employed in conjunction with an embodiment of a coiled tubing life monitor.

FIG. 1B is a chart representing fatigue life of the coiled tubing of FIG. 1A on a foot by foot basis.

FIG. 2A is an enlarged view of the coiled tubing life monitor depicted in FIG. 1A.

FIG. 2B is a cross-sectional view of the coiled tubing of FIG. 1A revealing a seam weld location detectable by the coiled tubing life monitor.

FIG. 3 is an enlarged view of the coiled tubing of FIG. 2B revealing radially segmented elements thereof for fatigue data analysis based on the known weld location.

FIG. 4 is a chart representing fatigue on the coiled tubing during a single ‘current’ run in contrast to the historical fatigue as shown in FIG. 1B.

FIG. 5A is a chart representing amplitude data obtained by an embodiment of a magnetic flux-leakage (MFL) coiled tubing life monitor indicative of substantially defect free condition.

FIG. 5B is a chart representing amplitude data obtained by the MFL monitor of FIG. 5A indicative of substantial coiled tubing defects.

FIG. 5C is an enlarged view of charted amplitude data obtained by the MFL monitor of FIGS. 5A and 5B, highlighting a particular coiled tubing ‘pinhole’ defect.

FIG. 6 is a flow-chart summarizing an embodiment of utilizing coiled tubing life monitor data to track the useful life of coiled tubing over repeat uses.

### DETAILED DESCRIPTION

Embodiments of a coiled tubing life monitor are described with reference to certain coiled tubing applications. More specifically, coiled tubing interventional applications within a well are detailed. However, embodiments of life monitors may be employed outside of a well intervention context. Indeed, even as coiled tubing is being initially wound about a reel before any use at all, monitors and techniques as detailed herein may be advantageously utilized. Additionally, monitors described herein are described as utilizing magnetic flux leakage detection techniques. However, in the case of fatigue life monitoring, alternative techniques for tracking coiled tubing rotatable orientation may be utilized where available. Regardless, embodiments of a life monitor are provided for sake of tracking coiled tubing structural conditions over repeated uses.

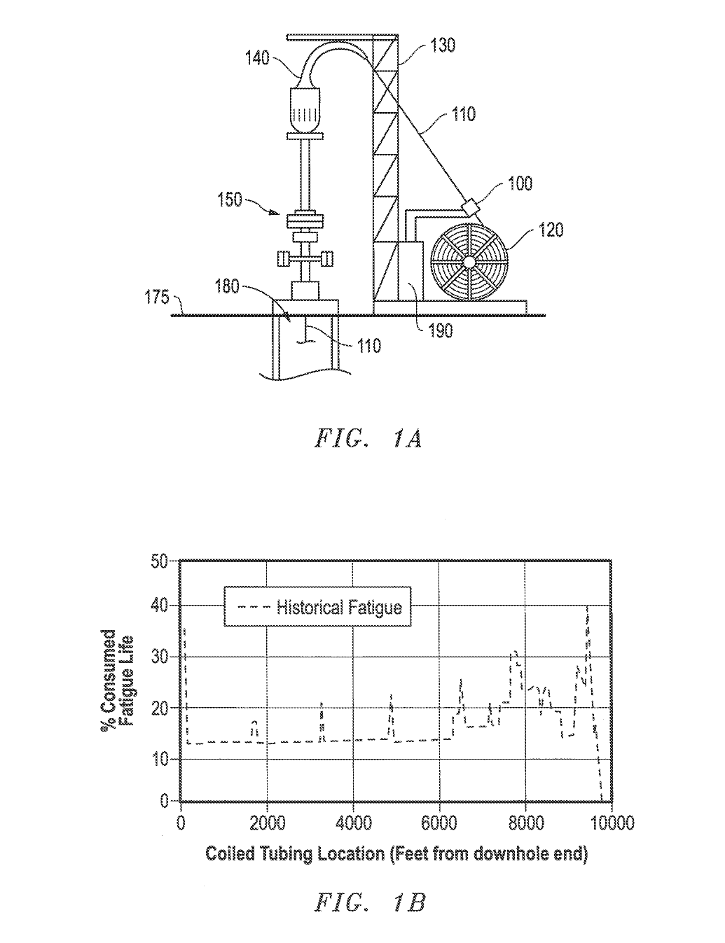

Referring now to FIG. 1A, an overview of an oilfield 175 is shown which accommodates a well 180. A system is positioned adjacent the well 180 so as to provide interventional accesses, for example, for a clean-out or other downhole application. More specifically, a coiled tubing reel 120 is located at the oilfield 175 from which coiled tubing 110 may be drawn and advanced into the well 180 for interventional applications.

The above noted coiled tubing 110 is unwound from the reel 120 and enters through a conventional gooseneck injector 140 supported by a mobile rig 130 at the oilfield 175. Thus, the tubing 110 may be controllably run through pressure control equipment 150 and into the well 180 for sake of downhole interventional applications as alluded to above.

As the coiled tubing 110 is unwound from the reel 120, fed through the injector and advanced through the well 180, it is repeatedly plastically deformed. Indeed, this cycled bending is naturally repeated in reverse at the end of downhole applications as the tubing 110 is withdrawn from the well 180 and injector 140 and wound back around the reel 120. Over time, these bend cycles induce considerable fatigue on the coiled tubing 110 through repeated stress and strain, ultimately affecting the overall useful life of the tubing. This is due to the fact that the coiled tubing 110 is of an alloy steel, a stainless steel or other suitable metal-based material, with diameter generally under about 3.5 inches. Thus, as it is cycled through the various bends, the repeated plastic deformation of the tubing 110 takes place.

Continuing with reference to FIG. 1A, the system is equipped with an embodiment of a coiled tubing life monitor 100. That is, as the coiled tubing 110 is advanced toward the well 180, or withdrawn from it, data about the tubing 110 may be tracked. In the embodiment shown, a control unit 190, having data storage and a processor, is provided with the system for sake of storing and analyzing such data. Indeed, given that fatigue life is largely a matter of repeated coiled tubing usage, the data acquired by the monitor 100 may be stored and historically tied to the specific coiled tubing 110.

In the embodiment of FIG. 1A, the data collected by the monitor 100 relates to dynamic tracking of the coiled tubing 110 in terms of location and orientation. So, for example, with added reference to location, FIG. 1B is a chart depicting fatigue life for upwards of 10,000 feet of coiled tubing 110 which may be monitored, foot by foot, as the tubing 110 is advanced or withdrawn from the well 180.

Continuing with reference to FIG. 1B, a known cumulative historical model of fatigue is actually depicted. That is, even before the coiled tubing 110 of FIG. 1A is put to use as shown, a historical plot of past use and accumulated fatigue may be available (e.g. at the control unit 190). As shown in FIG. 1B, the accumulated fatigue over past use is apparent at the Y-axis, where the percentage of consumed fatigue life is depicted. By way of more specific example, it is apparent that about 35% of the fatigue life has been consumed for the coiled tubing 110 at its downhole end, whereas no fatigue life has been consumed after about 10,000 feet or so. This makes sense given that the downhole end of the coiled tubing 110 would be utilized with each and every application of the tubing 110 while at the same time usage of coiled tubing toward the reel core would be more rare.

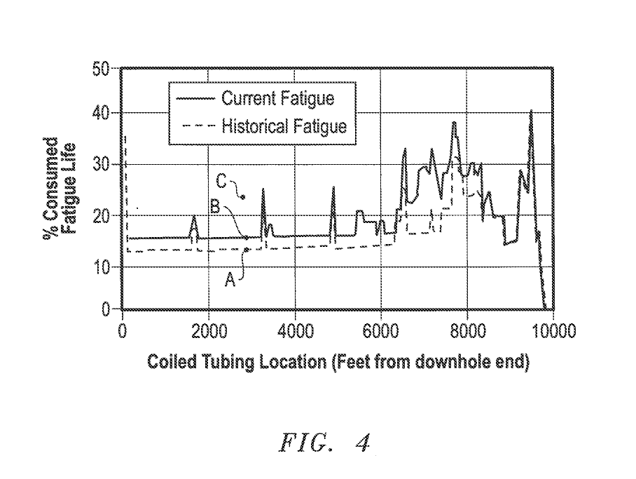

Continuing with reference to FIGS. 1A and 1B, the historical model of consumed fatigue life in FIG. 1B is a roughly accurate representation based on data actually collected from the monitor 100 of FIG. 1A during prior applications with the coiled tubing 110. That is to say, the plot line of consumed fatigue life is cumulative. By way of example, the entire length of the coiled tubing 110 may be represented with a plot line near 0% immediately following manufacture. However, this line begins to adjust relative the X-axis over usage history from the time that the coiled tubing 110 is initially wound around the reel 120 up through the set-up as depicted in FIG. 1A. By way of example, the depiction in FIG. 1B may be a cumulative representation of fatigue life following 10-100 uses of the coiled tubing 110 or more. Further, as a matter of comparative analysis, a particular application run with the coiled tubing 110, as shown in FIG. 1A, may be independently plotted against this historical model (see FIG. 4).

As detailed below, the monitor 100 may be employed in conjunction with techniques for enhancing the accuracy of consumed fatigue life modeling. This is achieved largely based on dynamic tracking of coiled tubing orientation relative a central axis thereof. Thus, more specific data is made available regarding the precise nature of coiled tubing bending during cycling as described above.

With this added detail available, significantly premature disposal of the coiled tubing 110 may be largely avoided. That is to say, a worst case scenario of fatigue based on an identically oriented bend for every bend in a cycling of the coiled tubing 110 need not be presumed. Rather, a more accurate accounting of bending during cycling may be obtained through use of the monitor 100. This more accurate accounting of the dynamic orientation of bending during cycling may translate into a greater degree of accuracy in terms of stress and strain on the coiled tubing 110 (on a foot by foot basis). Ultimately, this enhanced accuracy may be reflective of a notably lesser degree of fatigue, depending on coiled tubing location.

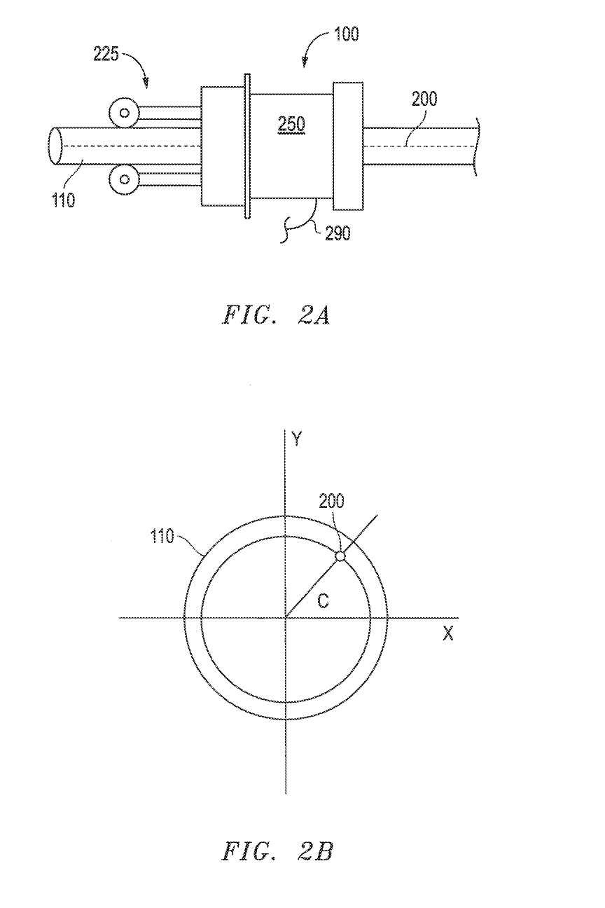

Referring now to FIG. 2A, an enlarged view of the coiled tubing life monitor 100 of FIG. 1A is depicted. In the embodiment shown, the monitor 100 is a magnetic flux leakage (MFL) detector. Thus, the location of a seamweld 200 may be tracked as the coiled tubing 110 is advanced through a body 250 of the monitor 100 (see also FIG. 2B). The monitor 100 is also outfitted with a roller-based guide mechanism 225 for stability as the coiled tubing 110 moves in either direction through the monitor 100. With added reference to FIG. 1A, the coiled tubing 110 may move leftward in a downhole direction or to the right as the tubing 110 is withdrawn toward the reel 120. In either case, cycling may ensue which takes a cumulative effect on overall fatigue life of the coiled tubing 110. Thus, orientation data, available due to radial positional tracking of the seamweld 200, may be transmitted to the control unit 190 for analysis via line 290.

Given that the monitor 100 is of an MFL variety in the embodiment described above, the seamweld 200 may be tracked due to its consistent and comparatively greater wall thickness relative the adjacent surface of the coiled tubing 110. Additionally, MFL tracking as noted may be used to keep a dynamic record of coiled tubing wall thickness, ovality or any changes thereto, generally (e.g. on a foot by foot basis). Of course, in other embodiments, alternative techniques for dynamically tracking coiled tubing orientation may be utilized irrespective of the added capacity for tracking wall thickness and/or ovality.

Referring now to FIG. 2B, a cross-sectional view of the coiled tubing 110 of FIGS. 1A and 2A is depicted revealing a location of the seamweld 200. The location of the seamweld 200 may be tracked by the monitor 100 as indicated. Once more, this tracking may take place relative X and Y axes which are established for reference by the monitor 100. Thus, during an application, as the coiled tubing 110 moves through the body 250 of the monitor 100, the seamweld 200 may shift one direction or another, reorienting relative the radial center (i.e. the central axis of the tubing 110). This dynamic position of the seamweld 200 may be detected with reference to the noted axes (X and Y). Indeed, the data may be recorded as a change in the angle C, determined based on the seemweld location in reference to the X axis.

Continuing with reference to FIG. 2B, this change in seamweld location represents a change in coiled tubing orientation over the course of use, which may have an affect on fatigue life as described above. For example, consider the unlikely scenario that the seamweld location were to remain static over multiple uses of the coiled tubing 110 (e.g. with angle C unchanging). In this case, every bend during repeated cycling would be the same and the rate of fatigue damage for the coiled tubing would correspond to the “worst case scenario”. That is, for a given segment of the coiled tubing, a presumption of maximum fatigue damage would be made, where, at the same location, the OD farthest away from the neutral axis the same bend would be presumed over multiple cycles. However, in practical application, it is much more likely that the coiled tubing orientation does not remain consistent. Further, this coiled tubing orientation may be tracked with reference to the seamweld 200 as described. Thus, a more accurate accounting of cumulative fatigue on the coiled tubing 110 may be recorded on a segment by segment basis axially (e.g. foot by foot), followed by an element by element basis circumferentially (e.g., every 30 degrees). More specifically, maximum “worst case scenario” fatigue based on static orientation of the coiled tubing 110 over multiple uses need not be presumed. Rather, a more accurate picture may be provided.

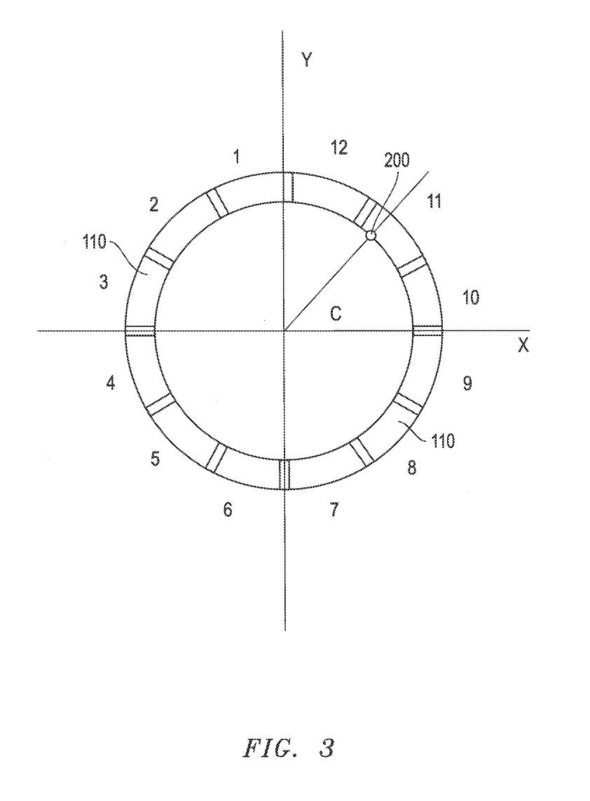

Referring now to FIG. 3, an enlarged view of the coiled tubing 110 of FIG. 2B is provided revealing an embodiment of enhancing fatigue accuracy. Specifically, the tubing 110 is shown divided into circumferentially discretized elements (1-12). The positioning of these elements (1-12) with respect to the neutral axis of the bending events may be tracked over the course of various applications based on the known location of the seamweld 200 as described above. Thus, fatigue based on cycling and changing orientation may be independently accounted for on an element by element basis.

Of course, while FIG. 3 reveals 12 different circumferentially discretized elements (1-12), any practical number may be utilized for analysis. That is, once the monitor 100 of FIGS. 1A and 2A begins dynamic tracking of the seamweld 200, the cumulative fatigue effects at any number of additional circumferential points of the coiled tubing 110 may be determined in reference thereto. So, for example, in other embodiments, circumferentially discretized elements ranging from 4 to 100 or more may be established for analysis by a processor of the control unit 190 (see FIG. 1A). Along these lines, in one embodiment, resolution may also be enhanced commensurate with the number of radially disposed internal probes of the monitor 100 for acquisition of MFL data.

Of course, while an ever increasing number of elements may be established for sake of enhancing resolution, the actual amount of improvement in resolution may become smaller and smaller. Thus, as a practical matter, for conventional coiled tubing 110 of less than about 3.5 inches in outer diameter, the number of circumferentially discretized elements set for analysis is likely to range between about 4 and about 40.

For exemplary purposes, consider an application run with a coiled tubing 110 that is evaluated in terms of 12 different circumferentially discretized elements (1-12) as shown in FIG. 3. Where the seamweld angle C is determined to be at 45°, this may correspond with the angle of element 11 for sake of evaluation. Thus, elements 12, 1, 2, 3, 4, 5, 6, 7, 8, 9, and 10 may initially be at corresponding angle locations (0) 75°, 105°, 135°, 165°, 195°, 225°, 255°, 285°, 315°, 345°, and 15°, respectively. As such, each element (1-12) may be evaluated, in terms of cumulative stress and strain, according to the following:

$$ɛ = \frac{r sin θ}{R}$$

where epsilon (E), the bending strain, is calculated based on the cross-sectional radius (r) of the coiled tubing 110 in light of the bend radius (R) (either at the reel or the gooseneck) for each bend cycle of the in the application, which may be assessed for each individual element location (θ). Since each element is a known constant location in relation to the seamweld 200, wheneven the coiled tubing rotates during operation, the seamweld angle C changes accordingly. As a result, the individual element location (θ) will also change. Thus, with the bending strain (E) at each circumferential discretized element in a segment determined for each bending cycle, a circumferentially cumulative and more accurate accounting of the fatigue model may be developed for the coiled tubing. Once more, this may be built up on a segment by segment basis, for example, to provide a historical fatigue life chart similar to what is shown in FIG. 1B. As detailed below, such a chart may be provided, with the Y-axis plotted with the highest consumed fatigue life of the elements for any given segment.

Referring now to FIG. 4, a chart representing fatigue on the coiled tubing 110 during a single ‘current’ run is provided for sake of contrast or updating relative the historical fatigue as shown in FIG. 1B. Indeed, the historical plot line (--) of FIG. 1B is again shown in FIG. 4 reflecting all prior accumulated fatigue over uses preceding a given current application, such as the one depicted in FIG. 1A. Further, the amount of additional fatigue that is placed on the coiled tubing 110 by way the current application is also now charted with a current plot line (-). Both plot lines are developed based on data acquired by the monitor 100 and analyzed according to techniques detailed hereinabove (see FIG. 3).

Continuing with reference to FIG. 4, the percentage of consumed fatigue life increases with the addition of the current application as would be expected. However, an enhanced degree of accuracy is provided in terms of the amount of consumed fatigue life is attributable to the current application, as the fatigue life consumed is tracked on each element of the segments, instead of assuming the “worst case scenario”.

By way of example, points A, B, and C are highlighted at about the 3,000 foot location of the coiled tubing for sake of illustrating the enhanced accuracy which may be available regarding the amount of consumed fatigue life. That is, through use of a monitor 100 and techniques as detailed hereinabove, a historical consumed fatigue life of about 14% (point A) may be estimated for this location prior to the current run. Further, the current run may be estimated to add on about 2% more to the consumed fatigue life, such that a 16% (point B) consumed fatigue life may be designated for the 3,000 foot location thereafter. However, without the advantage of the enhanced fatigue values provided by techniques detailed hereinabove, a consumed fatigue life of 25% (point C) might have been designated based on conventional “worst case scenario” modeling. Thus, the likelihood of premature disposal of the coiled tubing 110 is reduced.

As described above, enhanced accuracy is also provided on a location basis in terms of segment by segment fatigue analysis for the coiled tubing 110. For example, in the first 5,000 feet or so of coiled tubing, a relatively consistent amount of additional coiled tubing fatigue life is consumed by the run of the current application in contrast to the accumulated fatigue of prior historical runs. However, at about 7,000 feet, the amount of fatigue attributable to the current run is dramatically increased as compared to the accumulated fatigue of prior historical runs. On the other hand, almost no detectable added fatigue is attributable to the current run from 9,000 feet on, which may indicate reduction of consumed fatigue life due to rotation. Regardless, enhanced reliability of fatigue life estimates are provided across the entire length of the coiled tubing 110.

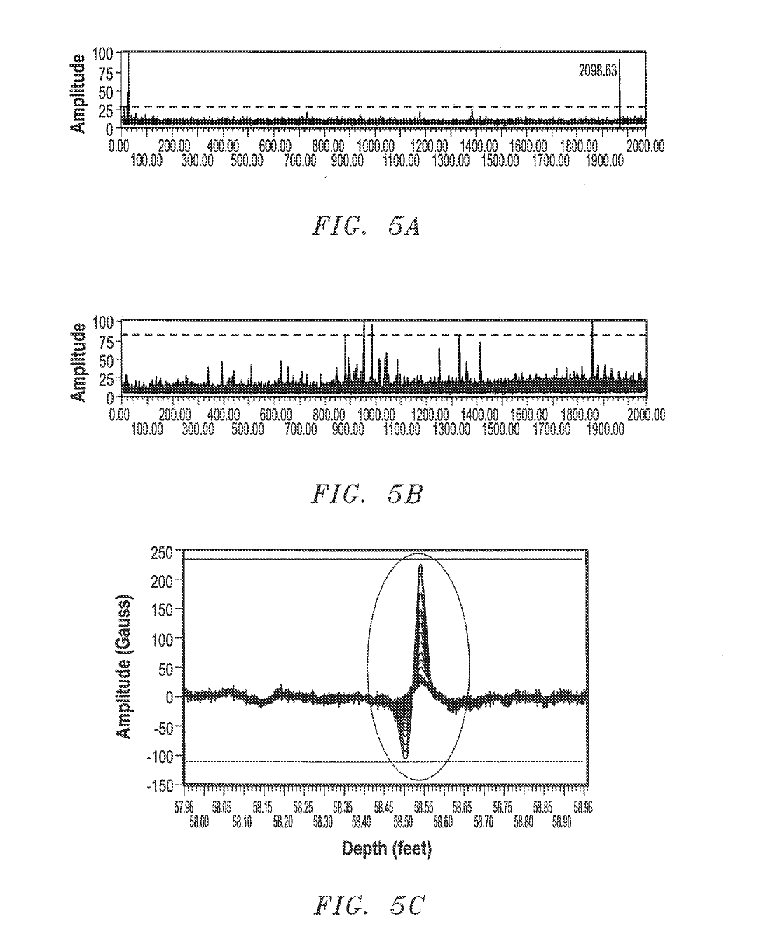

Referring now to FIGS. 5A-5C, an embodiment of utilizing data obtained from the monitor 100 of FIG. 1A is described. More specifically, where the monitor is of an MFL variety, amplitude data may be analyzed for emergence of defects irrespective of bend-induced fatigue. Thus, reliability of the coiled tubing 110 may continue to be monitored in additional ways.

With specific reference to FIG. 5A, a chart is shown representing amplitude data obtained by an MFL monitor 100 which is reflective of a substantially defect-free condition in the coiled tubing. Notice that spikes in amplitude are only detected at the outset and conclusion of the application runs. Continuing with reference to FIG. 5B, however, a host of amplitude spikes are depicted as defects in the coiled tubing begin to emerge following repeated uses. Indeed, with particular reference to FIG. 5C, an enlarged view of a ‘pinhole’ defect is shown.

Discrete amplitude changes in the coiled tubing which emerge following repeated use may be reflective of a pinhole defect as noted, cracking, and/or significant changes in ovality or wall thickness. Regardless, the long term reliability of the coiled tubing may be affected. Thus, in one embodiment, a predetermined amplitude threshold may be set for use in establishing reliability of the coiled tubing over time. For example, in FIG. 5A, a baseline amplitude of 25 Gauss is set which is substantially above the average detected amplitude of the MFL monitor (see FIG. 1A). Therefore, when an average detected amplitude threshold of about three times the initial baseline is exceeded (at 75 Gauss), the coiled tubing may be deemed as indication of reliability degradation. Such may or may not be directly reflective of fatigue versus other conditions. Nevertheless, an accurate measure of coiled tubing reliability may be provided.

By the same token, a more discrete emergence of defect, as opposed to an amplitude average, may also be employed in verifying coiled tubing reliability. For example, with reference to FIG. 5C, the emergence of any individual amplitude spike or pattern of spikes, over certain predetermined values may render the coiled tubing ‘unreliable’. These techniques of analysis are consistent with those described in International Application No. PCT/US2012/23122, for a “Pipe Damage Interpretation System”, filed Jan. 30, 2012, incorporated herein by reference in its entirety as detailed hereinabove.

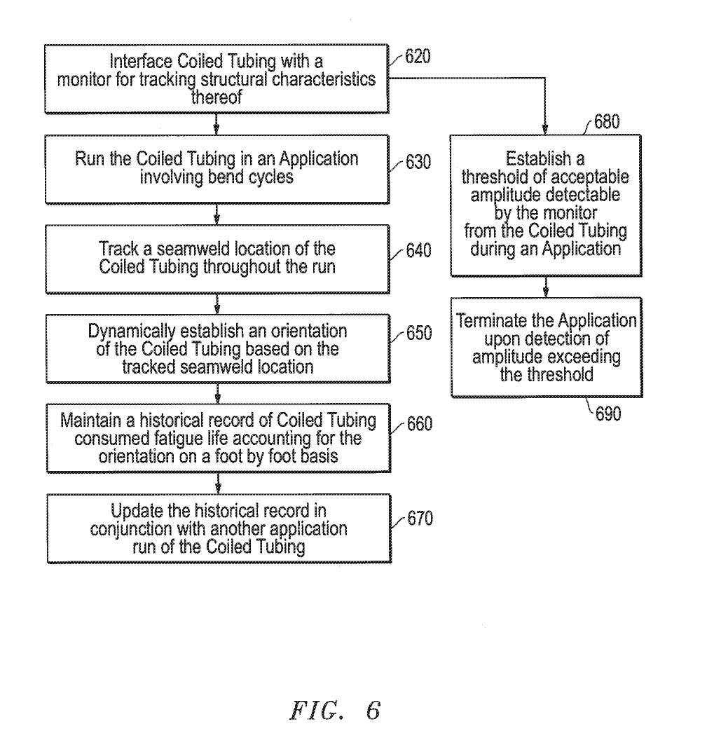

Referring now to FIG. 6, a flow-chart summarizing an embodiment of utilizing coiled tubing life monitor data to track the useful life of coiled tubing over repeat uses is shown. For example, once interfaced with the coiled tubing, the monitor may be utilized for tracking structural characteristics 620. As detailed immediately hereinabove, thresholds of acceptable amplitudes that are detectable by the monitor may be established and, for example, stored at the control unit 190 of FIG. 1A. Thus, as indicated at 690, the application may be terminated or flagged upon detection of an exceeded threshold (e.g. amplitude average, incremental amplitude over successive run, discrete level, pattern, etc.).

Continuing with reference to FIG. 6, the application may specifically be involved in running the coiled tubing through various bend cycles as indicated at 630. Thus, a seamweld location of the coiled tubing may be tracked throughout the run (640). This in turn, may be used to help dynamically establish coiled tubing orientation as noted at 650. Therefore, a historical record of consumed fatigue life of the coiled tubing may be maintained as indicated at 660 which accounts for the orientation on a location specific basis (i.e. foot by foot of the tubing). Once more, as noted at 670, this historical record may be updated and contrasted against each new run of the coiled tubing. As such, an up to date record of fatigue life may be continuously available which is of enhanced accuracy, heretofore unavailable.

Embodiments described hereinabove provide for enhanced accuracy in terms of fatigue life monitoring for coiled tubing over the course of multiple uses. As a practical matter, techniques utilized herein may help avoid premature retiring of coiled tubing based on inaccurate worst case scenario modeling. At the same time, however, the enhanced accuracy also may help to avoid potentially catastrophic circumstances where perceived inaccuracies in tracking of fatigue life result in overextended coiled tubing usage.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Furthermore, the foregoing description should not be read as pertaining only to the precise structures described and shown in the accompanying drawings, but rather should be read as consistent with and as support for the following claims, which are to have their fullest and fairest scope.

We claim:

1. A method of monitoring fatigue life of coiled tubing, the method comprising:
establishing a fatigue life model for the coiled tubing to account for repeated bend cycles of the coiled tubing during use;
using the coiled tubing in an operation that includes bend cycles;
monitoring the coiled tubing during said using, said monitoring comprising tracking radial orientation of the coiled tubing during successive bend cycles; and
determining a current fatigue life of the coiled tubing based on data that comprises the tracked orientation and the fatigue life model.

2. The method of claim 1 wherein the operation is selected from a group consisting of an operation of winding the tubing about a reel and advancing the tubing into a well for an interventional application therein.

3. The method of claim 1 wherein said determining comprises analyzing fatigue condition on a segment by segment basis from one end of the coiled tubing to another.

4. The method of claim 1 wherein said determining comprises analyzing fatigue condition of the coiled tubing in a circumferential element by element manner.

5. The method of claim 1 wherein said tracking comprises detecting a seamweld location of the coiled tubing during said using.

6. The method of claim 5 wherein said tracking is achieved with a magnetic flux leakage data monitor, the method further comprising:
interfacing the coiled tubing with the monitor during said using;
statically establishing an angular reference plot for the monitor relative the interfacing coiled tubing;
circumferentially establishing a plurality of circumferential discretized elements of the interfacing coiled tubing relative the seamweld; and
analyzing a fatigue condition for each of the elements based on dynamic angular position thereof in reference to the plot during said using.

7. The method of claim 6 wherein the plurality of circumferentially discretized elements comprise at least about 4 circumferentially discretized elements.

8. The method of claim 1 further comprising maintaining a historical record of fatigue life following said determining.

9. The method of claim 8 further comprising:
utilizing the coiled tubing in another operation that includes bend cycles; and
updating the historical record of fatigue life based on said utilizing.

10. A method of monitoring coiled tubing reliability, the method comprising:
interfacing the coiled tubing with a magnetic flux data monitor;
establishing at least one threshold using data detectable by the monitor;
using the coiled tubing in an operation; and flagging the operation upon detection off amplitude exceeding the threshold.

11. The method of claim 10 wherein the threshold is determined based on a baseline amplitude detected from the coiled tubing in advance of said using of the coiled tubing.

12. The method of claim 10 wherein the threshold is predetermined by amplitude detection from the coiled tubing in advance of said using of the coiled tubing.

13. The method of claim 10 further comprising an action following said flagging, said action selected from a group consisting of terminating the operation and identifying the axial location of a potentially damaged section of the coiled tubing.

14. The method of claim 11 wherein the amplitude exceeding the threshold is indicative of an emergence of a defect condition selected from a group consisting of a pinhole, cracking, a change in ovality, and a change in wall thickness.

15. The method of claim 11 wherein the amplitude exceeding the threshold presents in a manner selected from a group consisting of an average of detected amplitude, a pattern of detected amplitude and a spike in amplitude.

16. A coiled tubing life monitor system comprising:
a coiled tubing for use downhole in a well;
a monitor for interfacing said coiled tubing during an operation therewith;
a storage unit for acquiring data indicative of structural characteristics of said coiled tubing from said monitor; and
a processor for analyzing said data to determine reliability of said coiled tubing in light of the operation, the reliability relating to a condition selected from a group consisting of fatigue life accounting for coiled tubing orientation during the operation and defectiveness indicated by acoustic forms of the data.

17. The coiled tubing life monitor system of claim 16 wherein said coiled tubing comprises a seamweld structural characteristic, an accuracy of the fatigue life condition enhanced thereby.

18. The coiled tubing life monitor system of claim 16, further comprising:
a reel for accommodating said coiled tubing at an oilfield surface adjacent the well; and
an injector for driving the coiled tubing into the well, the operation selected from a group consisting of winding the coiled tubing about the reel and advancing the coiled tubing into the well.

19. The coiled tubing life monitor system of claim 18, wherein the operation is selected from a group consisting of winding the coiled tubing about said reel and the driving with said injector.

20. The coiled tubing life monitor system of claim 16, wherein said monitor is a magnetic flux leakage detector.
